(19) United States
(12) Patent Application Publication
(10) Pub. No.: US 2015/0371292 A1
(43) Pub. Date: Dec. 24, 2015

(54) APPARATUS, CHARGING SYSTEM AND CHARGING METHOD

(71) Applicant: Toru AKUTSU, Kanagawa (JP)

(72) Inventor: Toru AKUTSU, Kanagawa (JP)

(21) Appl. No.: 14/743,081

(22) Filed: Jun. 18, 2015

(30) Foreign Application Priority Data
Jun. 19, 2014 (JP) 2014-126152

(51) Int. Cl. G06Q 30/02

(52) U.S. Cl. CPC G06Q 30/0283

(57) ABSTRACT

An apparatus includes an acquisition unit configured to acquire setting information corresponding to an operator of the apparatus among setting information stored in a storage unit for each user for calculating a charging amount for a process, an execution of which is instructed; and a calculation unit configured to calculate the charging amount related to the process by using the setting information acquired by the acquisition unit.

### BACKGROUND OF THE INVENTION

1. Field of the Invention The disclosures herein generally relate to an apparatus, a charging system and a charging method.

2. Description of the Related Art

Generally, a user is charged with utilization of an image forming apparatus such as a copy machine which is set in a store such as a convenience store. Moreover, also in a school, a company or the like, a student, an employee or the like may be charged with utilization of an image forming apparatus.

A charge amount is generally determined according to a utilization mode. For example, a color copy is more expensive than a monochrome copy.

Moreover, the charge amount increases as a number of output sheets increases.

However, conventionally, calculation methods for charge amounts have been irrespective of utilization modes. Therefore, for example, it has been difficult to change a charge amount depending on a situation of usage of an image forming apparatus, e.g. which user uses the image forming apparatus.

Japanese Published Patent Application No. 2003-330686 discloses a network printing system which allows a multi-functional peripheral (MFP) on a network to print if an accumulated number of printing sheets is less than an upper limit preliminarily set for each user.

### SUMMARY OF THE INVENTION

It is a general object of at least one embodiment of the present invention to provide an apparatus, a charging system and a charging method that substantially obviate one or more problems caused by the limitations and disadvantages of the related art.

In one embodiment, an apparatus includes an acquisition unit configured to acquire setting information corresponding to an operator of the apparatus among setting information stored in a storage unit for each user for calculating a charging amount for a process, an execution of which is instructed; and a calculation unit configured to calculate the charging amount related to the process by using the setting information acquired by the acquisition unit.

In another embodiment, a charging system includes an apparatus and a storage device connected to the apparatus via a network. The apparatus includes an acquisition unit configured to acquire setting information corresponding to an operator of the apparatus among setting information stored in the storage device for each user for calculating a charging amount for a process, an execution of which is instructed; and a calculation unit configured to calculate the charging amount related to the process by using the setting information acquired by the acquisition unit.

In yet another embodiment, a charging method includes acquiring setting information corresponding to an operator of an apparatus among setting information stored in a storage unit for each user for calculating a charging amount for a process, an execution of which is instructed; and calculating the charging amount related to the process by using the acquired setting information.

According to the embodiment of the present application, flexibility in charging for utilization of an apparatus can be enhanced.

### BRIEF DESCRIPTION OF THE DRAWINGS

Other objects and further features of embodiments will be apparent from the following detailed description when read in conjunction with the accompanying drawings, in which:

FIG. 1 is a diagram illustrating an example of a configuration of a charging system according to a present embodiment;

FIG. 2 is a diagram illustrating an example of a hardware configuration of an image forming apparatus according to the present embodiment;

FIG. 3 is a diagram illustrating an example of a functional configuration of the charging system according to the present embodiment;

FIG. 4 is a sequence diagram for explaining an example of a processing procedure of login processing to the image forming apparatus according to the present embodiment;

FIG. 5 is a diagram illustrating an example of a display example of a login screen according to the present embodiment;

FIG. 6 is a diagram illustrating a configuration of a charging classification storage unit according to the present embodiment;

FIG. 7 is a diagram illustrating an example of a configuration of a charging setting storage unit according to the present embodiment;

FIG. 8 is a flowchart for explaining an example of a processing procedure performed by the image forming apparatus in response to a request to execute a job according to the present embodiment;

FIG. 9 is a diagram illustrating an example of a configuration of log information according to the present embodiment;

FIG. 10 is a diagram illustrating an example of a configuration of a charging information storage unit according to the present embodiment;

FIG. 11 is a sequence diagram for explaining an example of a processing procedure of display processing for report information based on the charging information according to the present embodiment; and

FIG. 12 is a diagram illustrating a display example of the report information according to the present embodiment.

### DESCRIPTION OF THE PREFERRED EMBODIMENTS

In the following, embodiments of the present invention will be described with reference to the accompanying drawings.

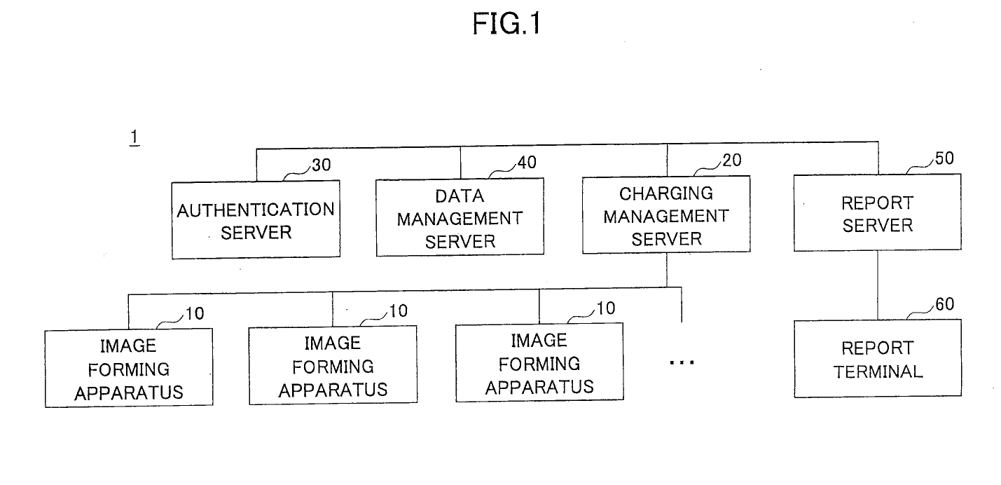

FIG. 1 is a diagram illustrating an example of a configuration of a charging system according to a present embodiment. In FIG. 1, the charging system 1 includes one or more image forming apparatuses 10, an authentication server 30, a data management server 40, a charging management server 20, a report server 50, a report terminal 60 and the like. Each of the image formation apparatuses 10 is connected to the charging management server 20 for a communications connection via a network such as a LAN (Local Area Network) or the Internet. The authentication server 30, the data management server 40, the charging management server 20 and the report server 50 are connected to one another for a communications connection via a network such as a LAN or the Internet. Meanwhile, in the present embodiment, the image forming apparatuses 10 are assumed to be installed in respective places in a campus of some university.

The image forming apparatus 10 is, for example, a printer, a copy machine, a facsimile machine, a multifunctional peripheral or the like. The authentication server 30 is one or more computers that authenticate a user (operator) of the image forming apparatus 10. The charging management server 20 manages set information for calculating a charge amount for utilization of the image forming apparatus (hereinafter referred to as “charging setting”). Although in the present embodiment, the charge amount will be explained as an example of a charge quantity, the charge quantity may be expressed by a value other than an amount of money. For example, the charge quantity may be expressed by points which are given to each user periodically. Moreover, the charging management server 20 also serves as a mediator between the image forming apparatus 10 and the authentication server 30, and between the image forming apparatus 10 and the data management server 40. By the charging management server 20 serving as a mediator, it can decrease the need to perform settings for the image forming apparatus 10 in order to access the authentication server 30 or the data management server 40.

The data management server 40 is one or more computers that store a history of charging information or the like. The charging information includes log information on a job (process) executed by the image forming apparatus 10, a charge amount calculated for the job, or the like. The report server 50 is one or more computers that generate report information on a situation of usage of the image forming apparatus 10 based on the history of charging information stored in the data management server 40.

Meanwhile, the authentication server 30, the data management server 40, the charging management server 20 and the report server 50 may be realized by being integrated into a computer.

The report terminal 60 receives an instruction to display report information from a user, and sends a request to generate a report to a report management server. The report terminal 60 displays the report information generated by the report management server in response to the request to generate the report. The report terminal 60 may be, for example, a personal computer (PC), a tablet terminal, a smartphone, a mobile phone or the like.

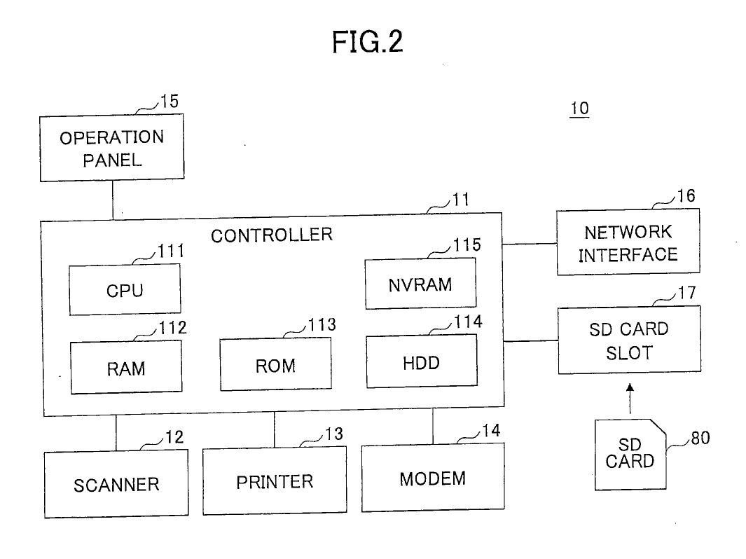

FIG. 2 is a diagram illustrating an example of a hardware configuration of the image forming apparatus 10 according to the present embodiment. In FIG. 2, the image forming apparatus 10 includes, as hardware, a controller 11, a scanner 12, a printer 13, a modem 14, an operation panel 15, a network interface 16, an SD (secure digital) card slot 17, and the like.

The controller 11 includes a CPU (central processing unit) 111, a RAM (random access memory), a ROM (read-only memory) 113, a HDD (hard disk drive) 114, a NVRAM (non-volatile random access memory) 115, and the like. The ROM 113 stores various programs, data used by the programs, and the like. The RAM 112 is used as a storage region, in which a program is loaded, a work region for the loaded program or the like. The CPU 111 realizes various functions by processing the program loaded in the RAM 112. The HDD 114 stores a program and various data used by the program or the like. The NVRAM 115 stores various set information or the like.

The scanner 12 is hardware (an image readout unit) that reads out image data from a manuscript. The printer 13 is hardware (a print unit) that prints print data on a print sheet. The modem 14 is hardware that connects the image forming apparatus 10 to a telephone line, and is used for executing transmission/reception of image data by facsimile communication. The operation panel 15 is hardware including an input unit, such as a button, which receives an input from the user, a display unit, such as a liquid crystal panel, or the like. The liquid crystal panel may be provided with a touch panel function. In this case, the liquid crystal panel doubles as the input unit. The network interface 16 is hardware that connects the image forming apparatus 10 to a network such as a LAN (Local Area Network). The LAN may be a wired network or may be a wireless network. The SD card slot 17 is used for reading out a program stored in an SD card 80. That is, in the image forming apparatus 10, not only a program stored in the ROM 113 but also the program stored in the SD card 80 are loaded onto the RAM 112 and executed. Meanwhile, other recording media (for example, a CD-ROM (compact disc read-only memory), a USB (universal serial bus) memory or the like) may be substituted for the SD card 80. That is, a kind of recording medium, which corresponds to a position of the SD card 80, is not limited to a predetermined one. In this case, the SD card slot 17 may be substituted for by hardware according to the kind of recording medium.

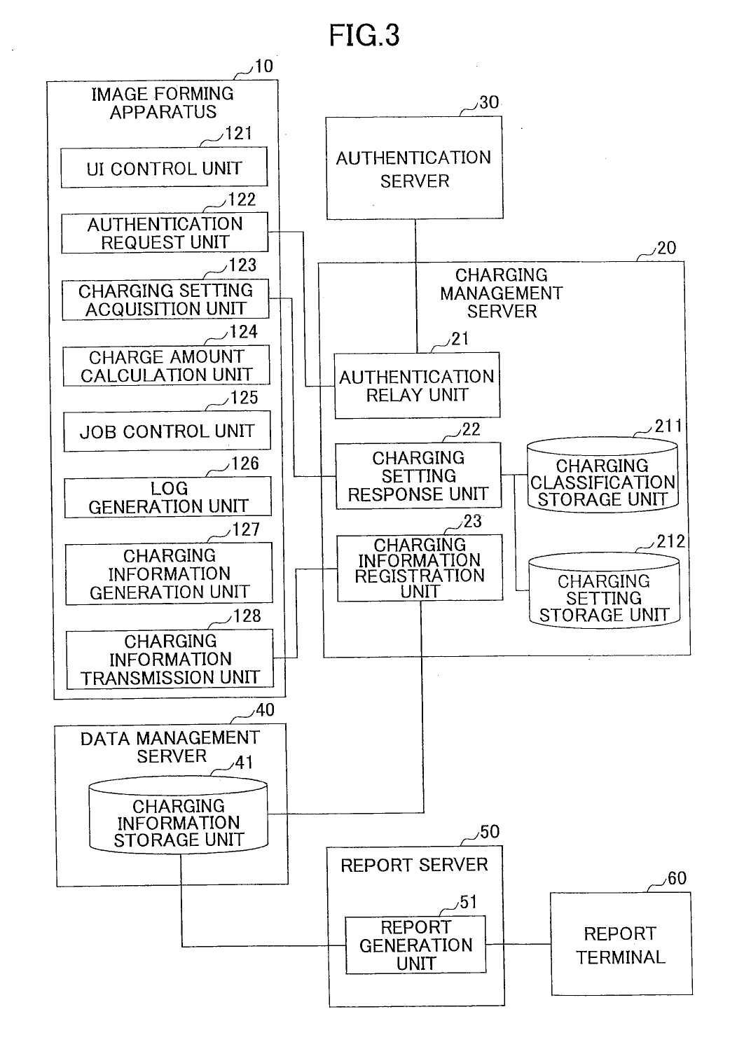

FIG. 3 is a diagram illustrating an example of a functional configuration of the charging system according to the present embodiment. In FIG. 3, the image forming apparatus 10 includes a UI (user interface) control unit 121, an authentication request unit 122, a charging setting acquisition unit 123, a charge amount calculation unit 124, a job control unit 125, a log generation unit 126, a charging information generation unit 127, a charging information transmission unit 128, and the like. Respective units, described as above, are realized by a process in which one or more programs installed in the image forming apparatus 10 are executed by the CPU 111.

The UI control unit 121 performs control of a process in response to an input to the operation panel 15, display control of information for the operation panel 15, or the like. The authentication request unit 122 sends an authentication request based on authentication information (a username, a password and the like) input by a user of the image forming apparatus 10 to the charging server 20, and receives an authentication result returned from the charging management server 20. Accordingly, the user of the image forming apparatus 10 is specified by the authentication request unit 122. Meanwhile, address information of the charging management server 20 of the user of the image forming apparatus 10 is, for example, preliminarily set in the image forming apparatus 10. Moreover, the authentication information may be stored in an IC (integrated circuit) card or may be biometric information, or the like.

The charging setting acquisition unit 123 acquires a charging setting for the user who logs in to the image forming apparatus 10 from the charging management server 20. The charge amount calculation unit 124 calculates a charge amount for a job, based on the charging setting acquired by the charging setting acquisition unit 123 and based on set information for the job (hereinafter referred to as “job setting”).

The job control unit 125 controls execution of a job which is instructed by the user to be executed. For example, the job control unit 125 controls an execution, such as printing, scanning, copying, sending facsimile, or the like. The log generation unit 126 generates log information for the executed job. The charging information generation unit 127 generates charging information for the executed job, based on the charging setting acquired by the charging setting acquisition unit 123 and based on the log information. The charging information transmission unit 128 sends the charging information generated by the charging information generation unit 127 to the charging management server 20.

The charging management server 20 includes an authentication relay unit 21, a charging setting response unit 22, a charging information registration unit 23, and the like. Respective units, described as above, are realized by a process in which one or more programs installed in the charging management server 20 are executed by the CPU in the charging management server 20. Moreover, the charging management server 20 uses a charging classification storage unit 211, a charging setting storage unit 212, and the like. Respective storage units, described as above, can be realized by an auxiliary storage device included in the charging management server 20, a storage device connected to the charging management server 20 via a network, or the like.

The authentication relay unit 21 forwards the authentication request from the image forming apparatus 10 to the authentication server 30, and returns an authentication result by the authentication server 30 to the image forming apparatus 10. Meanwhile, the image forming apparatus 10 may send the authentication request to the authentication server 30. That is, the image forming apparatus 10 may communicate directly with the authentication server 30. In this case, the charging management serve 20 need not include the authentication relay unit 21.

The charging setting response unit 22 specifies a charging classification of the user of the image forming apparatus 10 with reference to the charging classification storage unit 211, in response to an acquisition request for a charging setting from the image forming apparatus 10, and returns to the image forming apparatus 10 a charging setting stored in the charging setting storage unit for the specified charging classification. A charging classification is used for classifying user groups, to each of which the same charging setting is applied. For example, in the case where executed jobs are the same, when charging classifications are different for users related to execution instructions of the job, charging settings applied to the jobs are different, and, as a result, charge amounts can be different. The charging classification storage unit 211 stores a charging classification for each user. Accordingly, in the present embodiment, a charging setting can be set for each user.

The charging information registration unit 23 registers charging information sent from the image forming apparatus 10 to the data management server 40.

The data management server 40 is provided with a charging information storage unit 41. The charging information storage unit 41 can be realized by an auxiliary storage device or the like included in the data management server 40. The charging information storage unit 41 stores the charging information registered by the charging management server 20.

The report server 50 is provided with a report generation unit 51. The report generation unit 51 can be realized by a process in which one or more programs installed in the report server 50 are executed by a CPU in the report server 50. The report generation unit 51, in response to a request from the report terminal 60, reports information which is obtained by analyzing a history of charging information stored in the charging information storage unit 41 of the data management server 40.

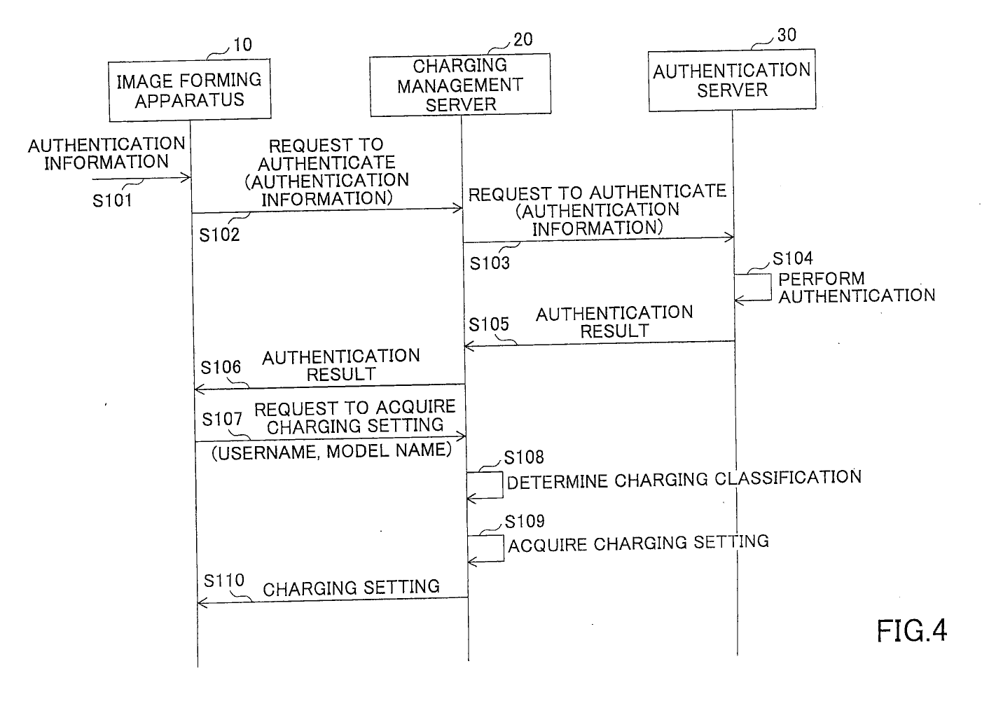

In the following, a processing procedure executed in the charging management system 1 will be explained. FIG. 4 is a sequence diagram for explaining an example of a processing procedure of login processing to the image forming apparatus 10.

The UI control unit 121 receives an input of authentication information from a user via a login screen displayed on the operation panel 15 (step S101).

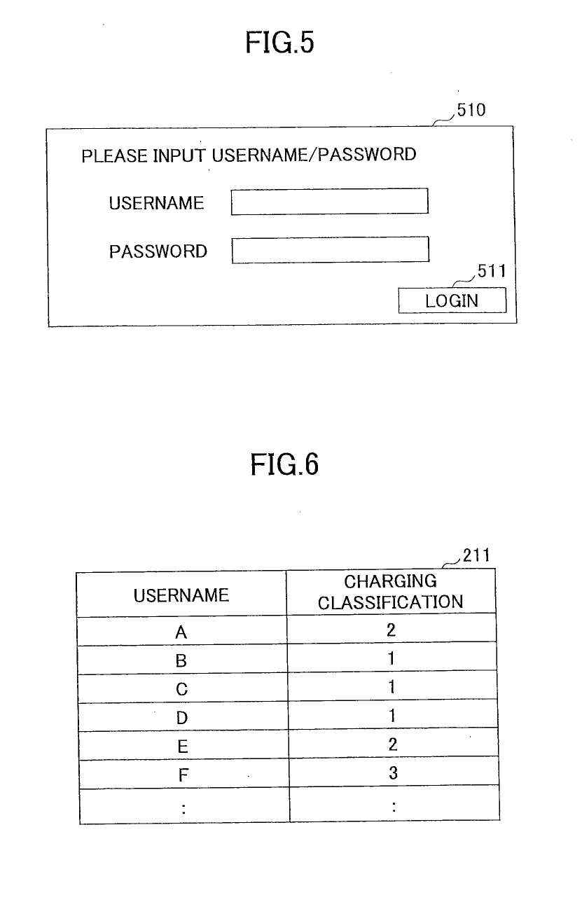

FIG. 5 is a diagram illustrating a display example of the login screen. In FIG. 5, the login screen includes input fields for username and password. Upon username and password being input and a login button being held down, the process at step S101 is performed. Meanwhile, in the case of using authentication information other than username and password, a screen suitable for the authentication information may be displayed.

Next, the authentication request unit 122 sends an authentication request including the input authentication information to the charging management server 20 (step S102). The authentication relay unit 21 in the charging management server 20, upon receiving the authentication request, forwards the authentication request to the authentication server (step S103).

The authentication server 30, upon receiving the authentication request, performs authentication for the authentication information included in the authentication request (step S104). For example, the authentication server 30 stores a list of authentication information of valid users. In the case where the list includes the authentication information, the authentication is determined to be successful. In the case where the list does not include the authentication information, the authentication is determined to be unsuccessful. The authentication server 30 returns an authentication result indicating whether the authentication is successful to the charging management server 20 (step S105).

The authentication relay unit 21 of the charging management server 20 returns the result of authentication to the image forming apparatus 10, which is a transmission source of the authentication request (step S106). In the case where the received result of authentication indicates that the authentication is unsuccessful, the image forming apparatus 10 maintains the state where the login screen 510 is displayed and does not perform the processes at step 5107 and further. Accordingly, in this case, the user cannot cause the image forming apparatus 10 to execute the job.

On the other hand, in the case where the received result of authentication indicates that the authentication is successful, the image forming apparatus 10 removes the login screen 510 and displays a screen for receiving requests for executing various jobs. Moreover, in this case, the authentication request unit 122 stores a username which is authenticated in, for example, the RAM 112 as a username of a login user.

Next, the charging setting acquisition unit 123 specifies the username of the login user and identification information of a model of the image forming apparatus 10 (hereinafter referred to as “model name”), and sends a request to acquire a charging setting to the charging management server 20 (step S107). The charging setting response unit 22 of the charging management server 20, in response to the acquisition request, referring to the charging classification storage unit 211, determines a charging classification corresponding to the username specified by the acquisition request (step S108).

FIG. 6 is a diagram illustrating an example of a configuration of the charging classification storage unit 211. As shown in FIG. 6, the charging classification storage unit 211 stores charging classifications, each of which corresponds to a username. FIG. 6 exemplifies the charging classifications classified into three groups, 1 to 3. For example, group 1 may be assigned to undergraduate students, group 2 may be assigned to postgraduate students and group 3 may be assigned to faculty and staff of a university, such as a professor. A method for assigning the charging classifications may be based on any other viewpoint.

Next, the charging setting response unit 22 acquires from the charging setting storage unit 212 a charging setting corresponding to the charging classification, determined at step S108, and corresponding to the model name specified by the request to acquire the charging setting (step S109).

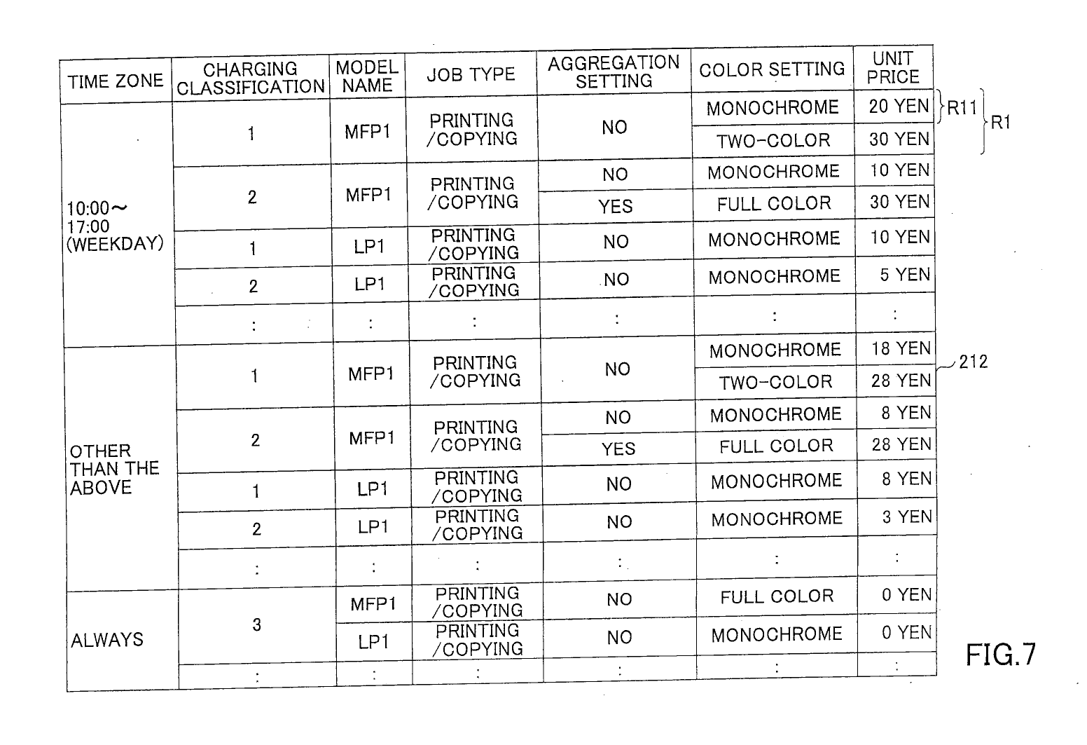

FIG. 7 is a diagram illustrating an example of a configuration of the charging setting storage unit 212. As shown in FIG. 7, the charging setting storage unit 212 stores a unit price for each time zone, charging classification, model name, and job setting. FIG. 7 illustrates an example in which a job type, an aggregation setting and a color setting are items included in the job setting. However, the items included in the job setting may be appropriately changed. Moreover, in the present embodiment, the unit price means a charge amount per an output page. Meanwhile, the job type means is a type of a job, such as printing, copying or scanning.

The time zone means a time period used in which the image forming apparatus 10 is used. Therefore, the process at step 109 acquires a charging setting in a line (record) corresponding to a time zone, to which a current time belongs, the charging classification determined at step S108, and the model name specified by the request to acquire the charging setting. For example, in the case where the current time is 14:00 in a weekday, the charging classification is “1”, and the model name is “MFP1”, a charging setting in a record R1 in FIG. 6 is acquired.

Meanwhile, FIG. 6 illustrates an example where the charging setting is classified for each model name. However, the charging setting may be classified for each machine body of the image forming apparatus 10, or a group classified based on a viewpoint different from the model. In this case, the request to acquire charging setting has only to include identification information for each machine body or identification information of the group.

Next, the charging setting response unit 22 returns the acquired charging setting to the image forming apparatus 10, which is a transmission source of the request to acquire the charging setting (step S110). The charging setting acquisition unit 123 of the image forming apparatus 10 stores the received charging setting in, for example, the HDD 114 or the RAM 112. Meanwhile, the charging setting may be deleted from the image forming apparatus 10 in response to a user's logout processing.

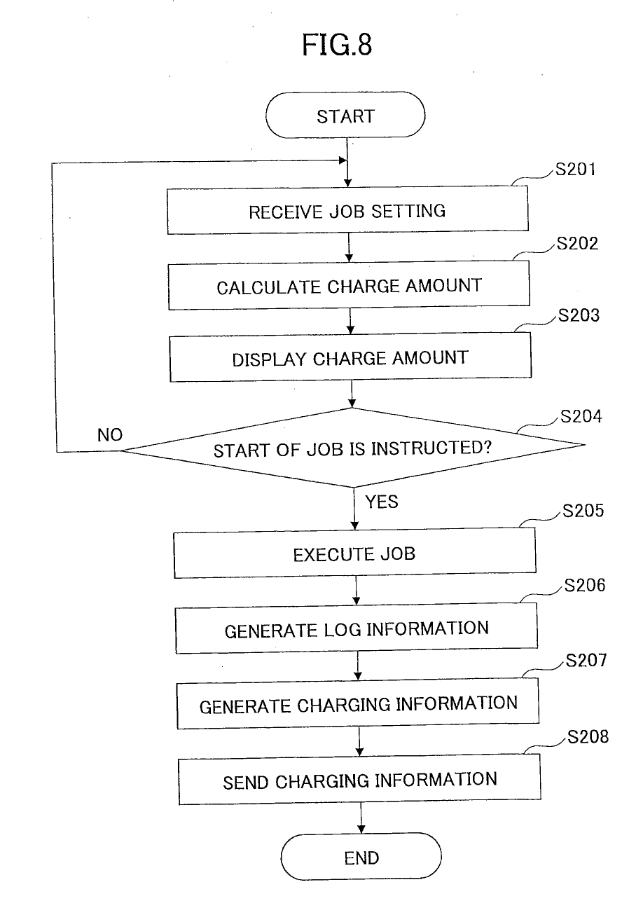

Next, the processing procedure executed by the image forming apparatus 10 in response to a request to execute a job will be explained. FIG. 8 is a flowchart for explaining an example of a processing procedure performed by the image forming apparatus 10 in response to the request to execute the job.

The UI control unit receives an input of a job setting from a user via a screen for setting job selected as an execution object. For example, in the case of a printing job related to document data preliminarily uploaded to a predetermined server, a copying job or the like, an aggregation setting, a color setting of the like is input as the job setting.

Next, the charge amount calculation unit 124 calculates a charge amount based on a charging setting, among charging setting acquired for the login user, in which the job type, the aggregation setting and the color setting coincide with a current job setting in the image forming apparatus 10 (step S202). The charging setting acquired for the login user means the charging setting acquired at step S110 S in FIG. 4. For example, in the case where the charging setting is a charging setting for the record R1 in FIG. 7, and the job type, the aggregation setting and the color setting are “printing”, “no aggregation”, “monochrome”, respectively, a record R11 is employed. Accordingly, in this case, the charge amount is calculated by multiplying 20 yen by a number of sheets to be output (page number of the print data).

Meanwhile, the present embodiment illustrates an example where the charging setting corresponding to a user and an image forming apparatus 10 is acquired by the image forming apparatus 10 upon the user performing login processing. The charging setting may be acquired after receiving the job setting (i.e. after the process at step S201). In this case, since the job setting is determined, a charging setting related to one record can be acquired in the charging setting storage unit 212. However, in this case, since a communication occurs each time the job setting is changed by the user, the charging setting is preferably acquired upon performing the login process in an environment in which an increase in communication load is undesirable.

Next, the UI control unit 121 displays the charge amount calculated by the charge amount calculation unit 124 on the operation panel 15 (step S203). The user is provided the opportunity to reconsider executing the job by being notified of the charge amount. Accordingly, in the case where the charge amount is not required to be displayed before the execution of the job, the processes at steps S202 and S203 may not be performed.

In the case of changing the job setting by a user who refers to a charge amount (step S204: NO), the processes at step S201 and further are repeated. On the other hand, in the case where an instruction to start the job is input via the operation panel 15 (step S204: YES), the job control unit 125 executes the job according to the job setting (step S205).

Next, the log generation unit 126 generates log information related to the executed job (step S206).

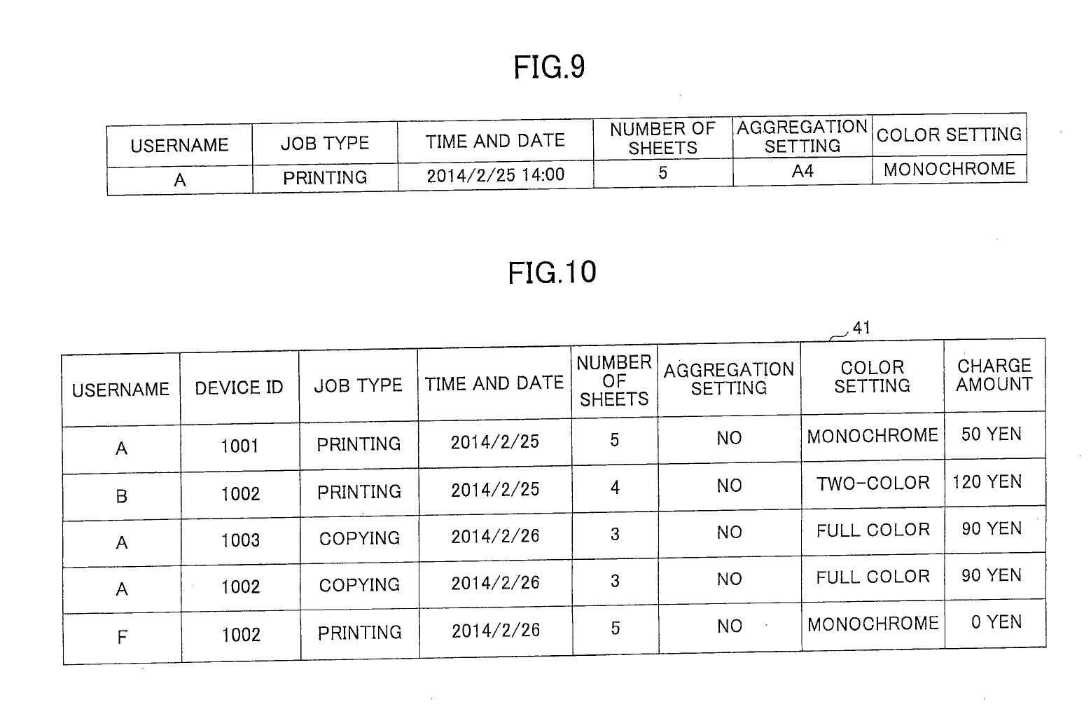

FIG. 9 is a diagram illustrating an example of a configuration of the log information. FIG. 9 illustrates an example of log information of one job. In FIG. 9, the log information includes a value for each item of a username, a job type, time and date, a number of sheets, an aggregation setting, a color setting or the like. The username indicates a username of the login user. The job type indicates a type of the executed job. The time and date indicates a time and date when the job is executed. The number of sheets indicates a number of actually output sheets by executing the job. The aggregation setting and the color setting indicate values of the aggregation setting or the color setting in the job setting.

Next, the charging information generation unit 127 generates charging information based on the log information or the like (step S207). The charging information includes identification information of a machine body of the image forming apparatus 10 (hereinafter referred to as “device ID”) and a charge amount, which are attached to the log information. The charge amount may be calculated in the process at step S202, or may be calculated again by the charging information generation unit 127 based on the log information at step S207. Specifically, the charge amount may be calculated by multiplying the unit price in the charging setting used at step S202 by the number of sheets included in the log information. The log information indicates actual achievement. Accordingly, by calculating the charge amount based on the log information, a charge amount according to an actual number of sheets can be calculated. As a result, for example, an occurrence of a problem of charging the user a charge amount greater than that of the number of actually output sheets in the case where a print processing is aborted by a user's instruction or the like can be prevented.

Next, the charging information generation unit 127 sends the generated charging information to the charging management server 20 (step S208). The charging information registration unit 23 of the charging management server 20, upon receiving the charging information, registers the charging information to the charging information storage unit 41 in the data management server 40.

FIG. 10 is a diagram illustrating an example of a configuration of the charging information storage unit 41. As shown in FIG. 10, the charging information storage unit 41 stores a history of the charging information. In each record, a charge amount in charging information is calculated for a charging classification to which a user related to the charging information belongs. For example, a user “F” related to the lowermost record belongs to the charging classification “3” according to FIG. 6. According to FIG. 7, in the case of the charging classification “3”, a charge amount is zero yen for any job. Therefore, the field of the charge amount in the record stores a value of “zero yen”. Meanwhile, in the field of the time and date in FIG. 10, a value of time is omitted for the sake of simplicity.

Meanwhile, the present embodiment, described above, illustrates an example in which the image forming apparatus 10 calculates a charge amount. However, the charging management server 20 may calculate the charge amount. In this case, the charging setting may not be acquired by the image forming apparatus 10. For example, at step S202, the image forming apparatus 10 may send to a charging apparatus a request to calculate a charge amount specifying a username of a login user, a model name and a job setting. The charging management server 20 may determine a charging classification and calculate the charge amount based on the username, the model name and the job setting, and return the calculated charge amount to the image forming apparatus 10. The same processing may be performed also at step S207. In this case, in the request to calculate the charge amount sent from the image forming apparatus 10 to the charging management server 20, log information may be specified.

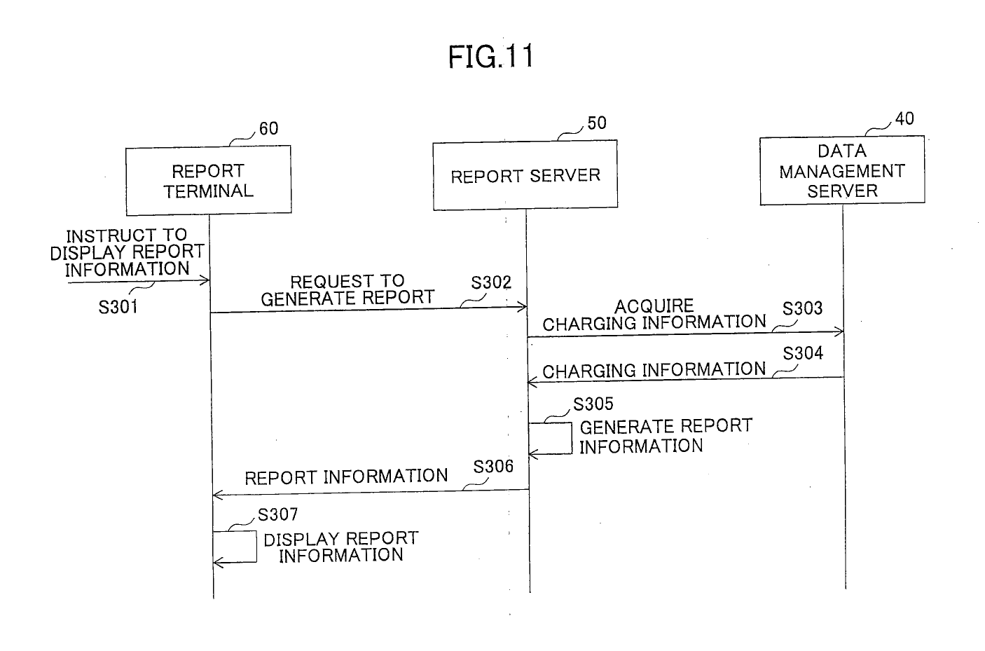

Next, an example of an application of charging information stored in the charging information storage unit 41 will be explained. FIG. 11 is a sequence diagram for explaining an example of a processing procedure of displaying report information based on the charging information.

First, a user such as an administrator inputs an instruction to display report information to the report terminal 60 (step S301). The report terminal 60 sends a request to generate the report information to the report server 50 (step S302). Meanwhile, in the instruction to display the report information, a parameter such as a term for narrowing charging information used for generating the report information may be specified. Moreover, a parameter representing a unit of tabulating charging information, such as for each username, for each device ID, for each job type, for each term (e.g. for each month) or the like, may be specified. The specified parameter is included in the request to generate report information and is sent to the report server 50.

The report generation unit 51 in the report server 50, upon receiving the request to generate report information, acquires necessary charging information from the charging information storage unit 41 of the data management server 40 based on the parameter specified in the request to generate report information (steps S303 and S304). The necessary charging information is, for example, charging information such that if the term is specified, a value of the time and date falls within the term.

Next, the report generation unit 51 analyzes the charging information based on the parameter specified in the request to generate report information, and generates the report information (step S305). For example, in the case where tabulation for each username is specified as the parameter, the report generation unit 51 tabulates charge amounts included in the acquired charging information for each username.

Next, the report generation unit 51 returns the generated report information to the report terminal 60 (step S306). The report terminal 60, upon receiving the report information, displays the report information (step S307).

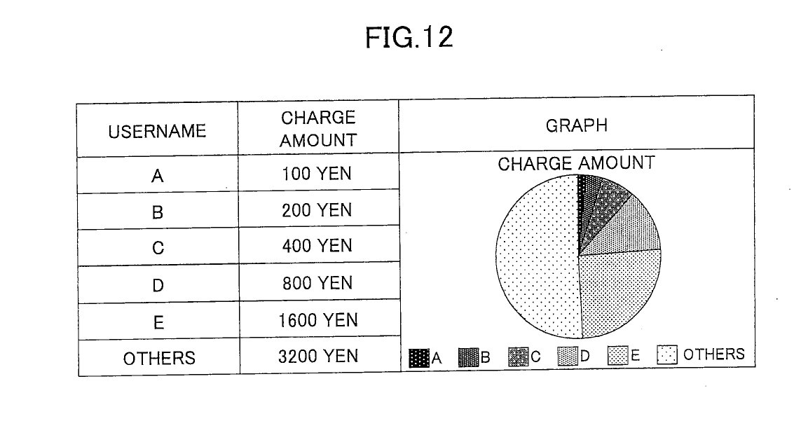

FIG. 12 is a diagram illustrating a display example of the report information. In FIG. 12, charge amounts tabulated for the respective usernames are shown in a table and also on a pie chart. The user can perceive the state of utilization of the image forming apparatus 10 with reference to the report information described above.

As described above, according to the present embodiment, the unit price related to the utilization of the image forming apparatus 10 can be made different for the respective users, for the respective time zones, for the respective models (or machine bodies) of the image forming apparatus 10, or the like. Accordingly, flexibility in charging related to a utilization of the image forming apparatus 10 can be enhanced.

For example, in the case of an image forming apparatus 10 provided in a university campus, staff members of the university can use the image forming apparatus free of charge, or unit prices for undergraduate students and for the postgraduate students can be made different from each other. Therefore, for example, a professor can print documents to be distributed to students in a lecture free of charge. Furthermore, a student is charged for making a copy of a lecture note of an other student.

Moreover, unit prices can be made different for respective machine bodies of image forming apparatuses 10. For example, by making a unit price for an image forming apparatus 10 of high use frequency, which is located in a convenient place and is always busy, relatively higher, and a unit price for an image forming apparatus 10 of low use frequency, which is located in an inconvenient place, relatively lower, it becomes possible to expedite the use of the image forming apparatus 10 of low use frequency. As a result, it can be expected that the use frequencies of the respective image forming apparatuses 10 are averaged.

Moreover, by making unit prices different for respective time zones or for respective machine bodies, for example, an image forming apparatus 10 located in a lecture room can be used during a lecture free of charge. That is, printing or copying required for the lecture can be performed free of charge.

Meanwhile, an operationally unnecessary item for the charging setting can be appropriately removed. For example, in the case where it is not necessary to make unit prices different for respective time zones or for respective model names (or machine bodies), these items may be removed from the charging setting. Moreover, in the case of making unit prices different from another point of view, an item corresponding to the point of view may be added to the charging setting.

Moreover, the present embodiment illustrates an example where the image forming apparatus 10 is provided in a university campus. However, the present embodiment may be applied to an image forming apparatus 10 located in other places, such as companies.

Moreover, the present embodiment may be applied to an apparatus shared by plural users, other than the image forming apparatus 10. For example, the present embodiment may be applied to utilization of an apparatus such as a projector, a digital camera, a video conference system, an electronic blackboard or the like.

Meanwhile, in the present embodiment, the image forming apparatus 10 is an example of an apparatus. The charging setting is an example of set information for calculating a charge amount. The username and the password are examples of input information. The charging setting acquisition unit 123 is an example of an acquisition unit. The charge amount calculation unit 124 or the charging information generation unit 127 is an example of a calculation unit. The charging management server 20 is an example of a storage device.

Further, the present invention is not limited to these embodiments, but various variations and modifications may be made without departing from the scope of the present invention.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The present application is based on and claims the benefit of priority of Japanese Priority Application No. 2014-126152 filed on Jun. 19, 2014, the entire contents of which are hereby incorporated by reference.

What is claimed is:

1. An apparatus comprising:
an acquisition unit configured to acquire setting information corresponding to an operator of the apparatus among setting information stored in a storage unit for each user for calculating a charging amount for a process, an execution of which is instructed; and
a calculation unit configured to calculate the charging amount related to the process by using the setting information acquired by the acquisition unit.

2. The apparatus as claimed in claim 1 wherein the setting information is further stored in the storage unit for each time zone, and the acquisition unit is configured to further acquire the setting information stored in the storage unit for a time zone, to which a time when the execution of the process is instructed belongs.

3. The apparatus as claimed in claim 1 wherein the setting information is further stored in the storage unit for each apparatus or for each model, and the acquisition unit is configured to further acquire the setting information stored in the storage unit for the apparatus or for a model of the apparatus.

4. A charging system comprising an apparatus and a storage device connected to the apparatus via a network, wherein the apparatus includes:
an acquisition unit configured to acquire setting information corresponding to an operator of the apparatus among setting information stored in the storage device for each user for calculating a charging amount for a process, an execution of which is instructed; and
a calculation unit configured to calculate the charging amount related to the process by using the setting information acquired by the acquisition unit.

5. The charging system as claimed in claim 4 wherein the setting information is further stored in the storage device for each time zone, and the acquisition unit is configured to further acquire the setting information stored in the storage device for a time zone, to which a time when the execution of the process is instructed belongs.

6. The charging system as claimed in claim 4 wherein the setting information is further stored in the storage device for each apparatus or for each model, and the acquisition unit is configured to further acquire the setting information stored in the storage device for the apparatus or for a model of the apparatus.

7. A charging method comprising:
acquiring setting information corresponding to an operator of an apparatus among setting information stored in a storage unit for each user for calculating a charging amount for a process, an execution of which is instructed; and
calculating the charging amount related to the process by using the acquired setting information.

8. The charging method as claimed in claim 7 further comprising:
storing the setting information in the storage unit for each time zone; and
acquiring the setting information stored in the storage unit for a time zone, to which a time when the execution of the process is instructed belongs.

9. The charging method as claimed in claim 7 further comprising:
storing the setting information in the storage unit for each apparatus or for each model; and
acquiring the setting information stored in the storage unit for the apparatus or for a model of the apparatus.
